(19) United States
(12) Patent Application Publication
(10) Pub. No.: US 2015/0063921 A1
(43) Pub. Date: Mar. 5, 2015

(54) METHODS AND APPARATUS FOR ARRESTING FAILURES IN SUBMERGED PIPELINES

(71) Applicant: Halliburton Energy Services, Inc., Houston, TX (US)

(72) Inventors: Steven Ray Lovett, Marlow, OK (US); Aimee Kathleen Greening, Duncan, OK (US)

(73) Assignee: Halliburton Energy Services, Inc., Houston, TX (US)

(21) Appl. No.: 14/014,865

(22) Filed: Aug. 30, 2013

(51) Int. Cl. F16L 1/26

(52) U.S. Cl. CPC F16L 1/26
USPC 405/184.2

(57) ABSTRACT

A packer apparatus includes a first spindle in axial moveable relation with a second spindle. The first spindle includes a pressure plate and the second spindle includes a base plate. A seal plate is disposed between the pressure and base plates. A brake is disposed between the pressure and seal plates. An elastomeric expansion boot is disposed between the seal and base plates. The pressure plate is configured to be actuated by fluid pressure within the pipeline to move the first spindle axially toward the second spindle from a first position to a second position. In the second position, the first spindle causes: the brake to move radially outward into engagement with an inner surface of the pipeline; and the seal plate to move axially toward the base plate to axially compress and radially expand the expansion boot into engagement with the inner surface of the pipeline.

### BACKGROUND

This disclosure relates generally to offshore pipelines, and more specifically to methods and apparatus for responding to failures in offshore submerged pipelines.

In offshore pipeline installations, as the pipeline is laid on the sea floor the pipeline is subjected to significant forces and moments that can compromise the integrity of the pipeline and, in some cases, cause failures. In the event the submerged pipeline is compromised to the point of failure, water rushes into the pipeline. Such failures are commonly referred to as wet buckles. Once a wet buckle occurs the flooded pipeline is too heavy to retrieve for repair and re-installation.

Companies that lay the pipeline keep a fleet of compressor ships on standby while the pipeline is being laid on the sea floor in case of a failure like a wet buckle. The compressor ships are present to pump the water out of the pipeline to facilitate repair of the buckled section, by allowing the pipeline to be pulled back to the surface, to the pipelay vessel, for removal of the damaged section. After the water has been removed, sections of the damaged pipeline can be retrieved and brought to the surface and the pipelay vessel can continue laying pipe onto the sea floor.

Pipeline failures like wet buckles are relatively rare. As such, during installation, the fleet of compressor ships hired by the pipeline installation company is generally inactive and serves no function for the installation process unless the rare failure occurs. The cost of the compressor ships and the associated service the ships and crew provide can reach the millions of dollars.

### BRIEF DESCRIPTION OF DRAWINGS

FIG. 1 schematically depicts a submerged pipeline installation system including wet buckle packers in accordance with this disclosure.

FIG. 2 depicts an elevation view of an example wet buckle packer.

FIG. 3 depicts an exploded view of different components of the packer of FIG. 2.

FIG. 4A depicts a section view of the example packer of FIG. 2 in an unengaged state within a pipeline.

FIG. 4B depicts a section view of the example packer of FIG. 2 in an engaged state within a pipeline.

FIG. 5 depicts an example method of arresting a failure in a submerged pipeline.

### DETAILED DESCRIPTION

In view of the foregoing costs and other inefficiencies associated with recovering from an offshore pipeline failure, examples according to this disclosure are directed to methods and apparatus for automatically responding to water invasion into the inner diameter of pipe in an offshore pipeline and rapidly deploying a sealing system that will prevent or inhibit the laid pipeline from being flooded with water.

A packer apparatus in accordance with this disclosure is configured to be arranged within and arrest a failure of a submerged pipeline. In one example, the packer apparatus includes a first spindle in axial moveable relation with a second spindle. The first spindle includes a pressure plate disposed adjacent a first end of the packer apparatus. The second spindle includes a base plate disposed adjacent a second end of the packer apparatus. A seal plate is disposed between the pressure and base plates. A brake is disposed between the pressure and seal plates. An elastomeric expansion boot is disposed between the seal and base plates. The pressure plate is configured to be actuated by fluid pressure within the pipeline to move the first spindle axially toward the second spindle from a first position to a second position. In the second position, the first spindle causes: the brake to move radially outward into engagement with an inner surface of the pipeline; and the seal plate to move axially toward the base plate to axially compress and radially expand the expansion boot into engagement with the inner surface of the pipeline.

In the following examples, the apparatus for arresting pipeline wet buckles (and other pipeline failures) is referred to as a wet buckle packer. However, the apparatus could also be referred to as a plug, a shutoff pig, a baffle, or other terms connoting a device that restricts, and ideally prevents fluid flow through an annular pipeline.

Wet buckle packers in accordance with this disclosure provide a number of functions once actuated. Packer apparatus in accordance with this disclosure are sometimes referred to as configured to arrest a failure like a wet buckle in a submerged pipeline. Arresting a failure in a pipeline includes a number of different functions. In both dry and wet buckles, for example, the pipeline failure can include a structural failure including a buckle that causes the pipeline to at least partially collapse on itself. The structural buckle can run along the length of the pipeline unless it is arrested. In wet buckles, water also invades the inner diameter of the pipe causing the pipeline to become flooded. Packer apparatus in accordance with this disclosure can function to arrest both a structural buckle in a submerged pipeline, whether from a dry or wet buckle, and deploy a sealing system that will prevent or inhibit the laid pipeline from being flooded with water in the event of a wet buckle. The packer seals the inner diameter of the pipeline to prevent or significantly inhibit water from flooding the submerged pipeline. Additionally, the packer deploys a braking mechanism to prevent or inhibit the packer from moving within the pipeline under the significant pressures introduced by the sea (or fresh) water entering the pipe from the wet buckle.

As noted above, wet buckle packers in accordance with this disclosure are configured to be automatically actuated to seal the pipeline inner diameter from ingress of water. The mechanisms for sealing and braking employed in a wet buckle packer can be actuated in a variety of ways. For example, electrical, hydraulic, or pneumatic supply lines can be run from the pipelay vessel on the surface to the packer. However, deploying supply lines from the surface downpipe to the packer will add cost and complexity to the system. The wet buckle packer could also include a power source, e.g., a battery that could be used to actuate the seal and brake mechanisms. However, the inclusion of a battery or other power source to actuate the packer will add cost and complexity to the device. In some cases, therefore, wet buckle packers are believed to be better configured to automatically actuate without the use of a power source or external actuation generator like a supply line run downpipe from the surface. As a result, while power sources or external actuation may be used in association with wet buckle packers as described herein, the examples of this disclosure are in accordance with what is believed to be the better configuration, where no such power or external source is necessary for actuation.

Wet buckle packers in accordance with this disclosure provide a new approach to seal and anchor a packer-type plug in place within a pipeline in the event of a wet buckle. The packers are designed to provide increased durability and to include component parts that protect against external variances. Example wet buckle packers can provide a number of advantages including, e.g., removing the high cost of air compressor standby in submerged pipeline installations and providing a simple and cost effective device for arresting failures in the pipeline.

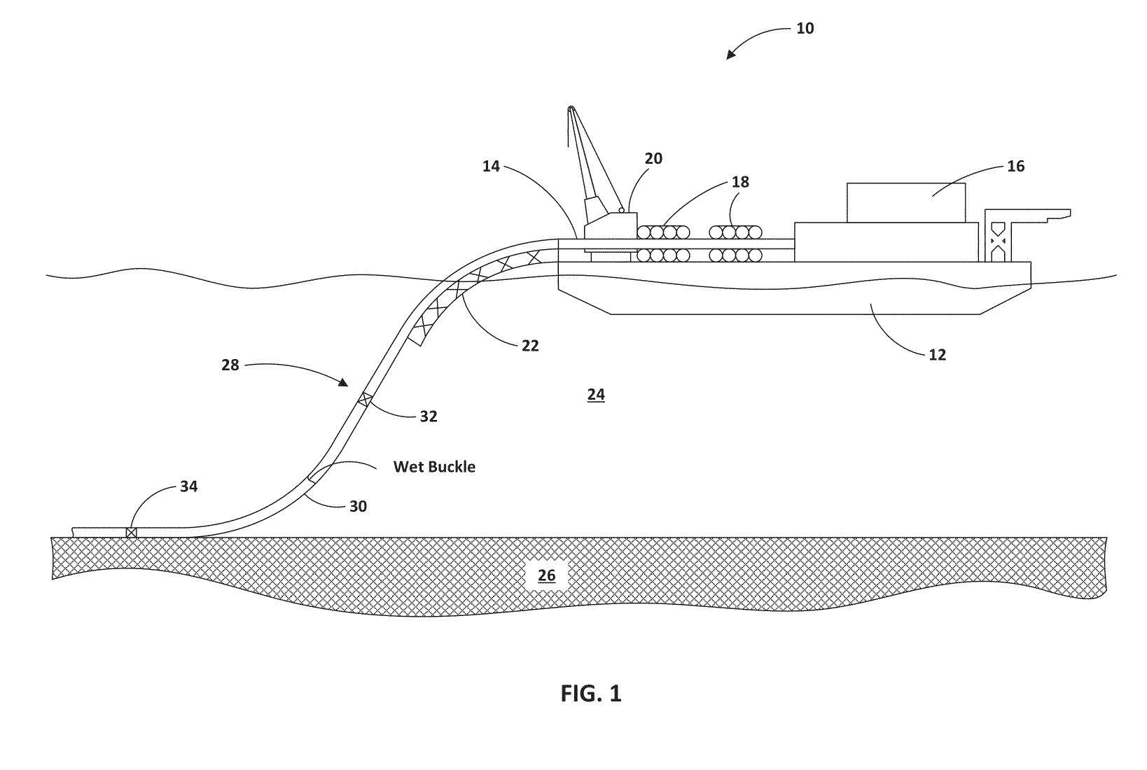

FIG. 1 depicts a submerged pipeline installation system 10. Offshore submerged pipelines can be installed in a number of ways. In general, individual pipes are transported by a cargo ship to a pipelay vessel at the pipeline installation location. The individual pipes are processed and connected to one another on the pipelay vessel and laid onto the sea floor. The pipelay vessel progressively welds individual pipes or welded pipe sections to one another to assemble the pipeline. As the pipeline is assembled the pipelay vessel moves across the surface of the water and the assembled pipeline is pulled off of the ship by the weight of the pipeline. As the pipeline is progressively pulled off of the back of the pipelay vessel it descends to the sea floor.

Two methods that are employed to install submerged pipelines are the “J” lay and the “S” lay. The moniker of each method represents the shape of the pipeline as it is pulled off of the pipelay vessel onto the sea floor. In a “J” lay, the pipeline is pulled off of the pipelay vessel substantially vertically to near the sea floor, where the pipeline bends to run horizontally along the floor. In an “S” lay, the pipeline is pulled off of the pipelay vessel substantially horizontally, bends vertically down toward the sea floor and then bends back horizontally away from the vessel to run along the sea floor. Although the following examples are described in the context of an “S” lay installation, wet buckle packers in accordance with this disclosure can also be employed in a “J” lay installation system or other pipeline installation methods not covered here.

FIG. 1 depicts a submerged pipeline installation system 10 for an “S” lay installation. In FIG. 1, system 10 includes pipelay vessel 12 and pipeline 14. Pipelay vessel 12 includes production factory 16, tensioners 18, crane 20, and stinger 22. As described in more detail below, after individual pipes are transported to and loaded on pipelay vessel 12, the pipes are conveyed into production factory 16. Production factory 16 includes a variety of processing stations for preparing pipes and coupling individual pipes into pipe sections and ultimately assembling pipeline 14, as will be known to persons skilled in the art.

Pipelay vessel 12 is shown floating in a body of water 24. Pipelay vessel 12 utilizes crane 20 to perform heavy lifting operations, including loading pipes from a cargo ship onto the vessel. In general, individual pipes on board pipelay vessel 12 are placed on an assembly line within production factory 16 and joints of the pipes are welded into pipeline 14. Pipeline 14 is held in tension between sea floor 26 and pipelay vessel 12 by pipeline tensioners 18 as the pipeline is lowered. As pipelay vessel 12 moves forward by pulling on a mooring system off of the bow, pipeline 14 is lowered from pipelay vessel 12 over stinger 22. Stinger 22 is attached to and extends from the stern of pipelay vessel 12, and provides support for pipeline 14 as it leaves pipelay vessel 12.

In practice, a cargo ship transports pipe sections (sometimes referred to as stands) to pipelay vessel 12. Crane 20 moves pipe sections from the cargo ship to pipelay vessel 12 onto cradles that form a conveyor system for moving pipe into production factory 16. Within production factory 16, a number of different operations are carried out to prepare and join pipe sections. For example, the pipe ends are beveled (and bevels are deburred). The pipe ends are preheated within production factory 16 and moved through a number of welding stations to join different sections with weld beads applied both to the outer and inner diameters of the sections at the joints. In some cases, a final welding station within production factory 16 applies a welded cap to the joints of pipe sections.

The joints of the welded pipe sections can also be tested within production factory 16. For example, the welded joints can pass through ultrasonic testing stations that apply water to the joints as the medium to transmit the ultrasonic signals. The ultrasonic signals can be processed by a computing system and graphically displayed for inspection by an operator.

After testing, the joints of the welded pipe sections can be grit blasted and a field joint coating can be applied. In some installation systems, each individual pipe is subjected to this process as it is welded to pipeline 14. In other cases, multiple pipes, e.g. two pipes in a double stand facility, are first welded together and then welded to the pipeline in the firing line onboard pipelay vessel 12. At any rate, the assembled pipeline 14 is ultimately conveyed through tensioners 18 and over stinger 22 to be dropped off of the stern of pipelay vessel 12 to sea floor 26.

As pipeline 14 is laid on sea floor 26, suspended pipe span 28 forms a shallow “S” shape between sea floor 26 and pipelay vessel 12. The “S” shape of suspended pipe 28 is sometimes referred to as the S-curve. Second curve 30 or the tail of the S-curve just before suspended pipe span 28 meets sea floor 26 is sometimes referred as the “sagbend.” The S-curve of pipeline 14 is controlled by stinger 22 and pipeline tensioners 18. Increases in the curvature of pipeline 14 cause increases in the bending moment on the pipeline, and, as a result, higher stresses. High stresses on pipeline 14 and, in particular, on suspended pipe span 28 can result in buckling of the pipeline 14. For example, a loss of tension in pipeline 14 during the pipe lay will normally cause pipeline 14 to buckle at a point along the suspended pipe span 28. A buckle in pipeline 14 is called a wet buckle if pipeline 14 has cracked or becomes damaged in a manner such that water is allowed to enter the inner diameter of the pipeline. The influx of water into the pipeline 14 greatly increases the weight of suspended pipe span 28 such that the pipe can become over stressed at a location along suspended pipe span 28, generally near stinger 22. In such circumstances, flooded pipeline 14 can break and drop from pipelay vessel 12 to sea floor 26. Regardless of whether pipeline 14 breaks in the event of a wet buckle, the increased weight can prevent recovery of and repair to pipeline 14 before the water is pumped out of the pipeline.

Examples according to this disclosure are directed to a wet buckle packer that can be deployed within the inner diameter of pipeline 14 as it is laid on sea floor 26. In FIG. 1, installation system 10 includes two wet buckle packers 32 and 34 deployed within pipeline 14. Packer 32 is deployed along suspended pipe span 28, while packer 34 is deployed downpipe where pipeline 14 meets sea floor 26. Wet buckle packers 32 and 34 are deployed within pipeline 14 with a hoist line or cable (not shown). In cases where multiple wet buckle packers are deployed in series, a hoist line may be coupled between the packers. In the example of FIG. 1, a hoist line may be coupled to a hoist on pipelay vessel 12 to packer 32 and another line can be coupled between packers 32 and 34. As will be apparent to persons skilled in the art, substantial benefits can be realized through an alternative configuration using only a single wet buckle packer, located generally in the position of depicted packer 34, positioned to prevent substantial inflow of water into the already-laid portion of pipeline 14 on sea floor 26.

Wet buckle packers 32 and 34 are configured to automatically respond to water invasion into the inner diameter of pipeline 14 and rapidly deploy a sealing system that will prevent the laid pipeline and pipeline above packer 32 from being flooded with sea water. For example, wet buckle packers 32 and 34 seal the inner diameter of pipeline 14 to prevent or significantly inhibit water from flooding the submerged pipeline. Additionally, wet buckle packers 32 and 34 deploy a braking mechanism to prevent or inhibit the packers from moving within pipeline 14 as a result of the pressures introduced by the sea water entering the pipe from the wet buckle.

In some cases one or more “piggy-back” lines may be laid from pipelay vessel 12 along with main pipeline 14. Piggy-back lines are generally constructed from smaller diameter pipes that are assembled in a similar manner as described above with reference to pipeline 14. The piggy-back lines are assembled in parallel with and are then coupled to pipeline 14, e.g., with a sleeve connected to top of the main pipeline 14 in which the piggy-back lines are received.

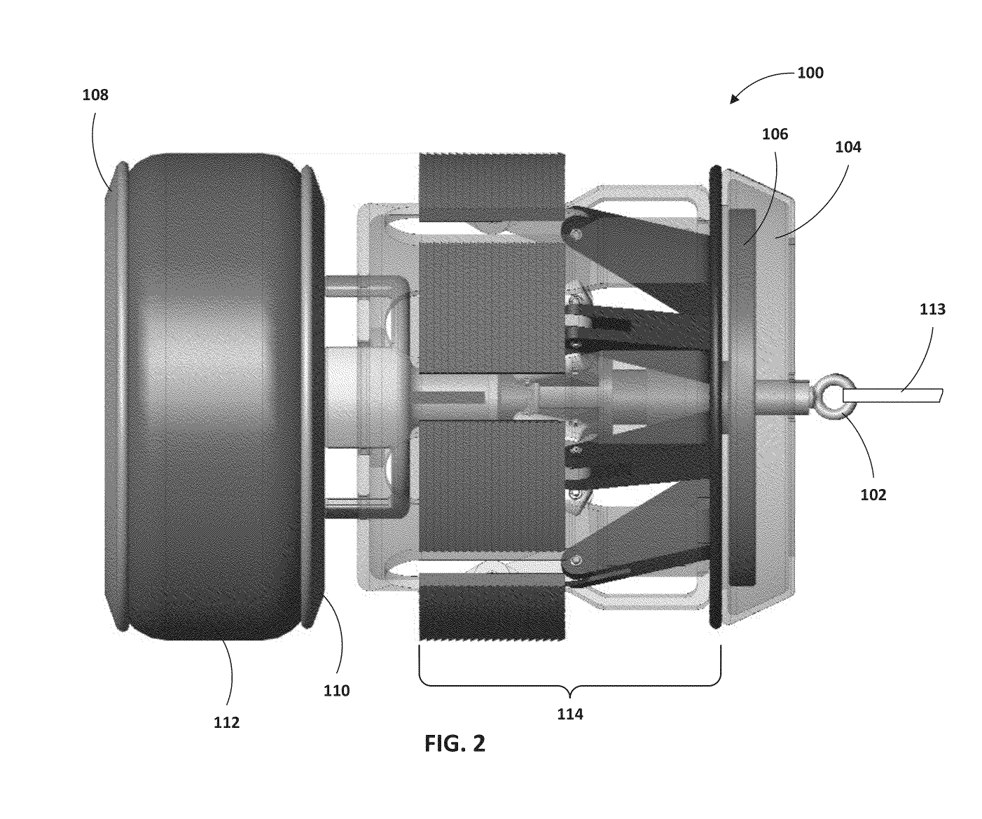

FIG. 2 depicts example wet buckle packer 100. Packer 100 includes a hoist ring 102, a perforated end cap 104, a first and second spindles 106 and 108, a seal plate 110, an elastomeric expansion boot 112, and a brake assembly 114. Packer 100 is coupled to hoist line 113 by hoist ring 102, which is connected to cap 104.

Packer 100 is configured to be deployed from a pipelay vessel down a submerged pipeline via hoist line 113. The generally cylindrical shape of packer 100 defined by the outer peripheries of cap 104, second spindle 108, seal plate 110, and expansion boot 112 are configured to slide within the pipeline as packer 100 is deployed downpipe from the pipeline vessel.

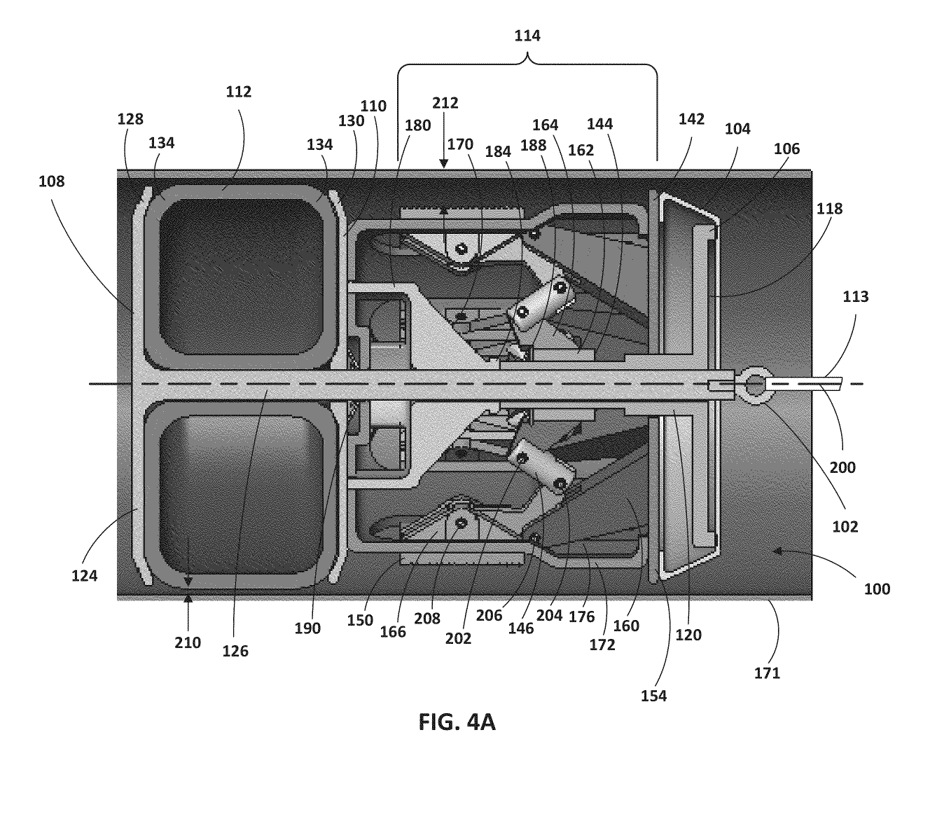

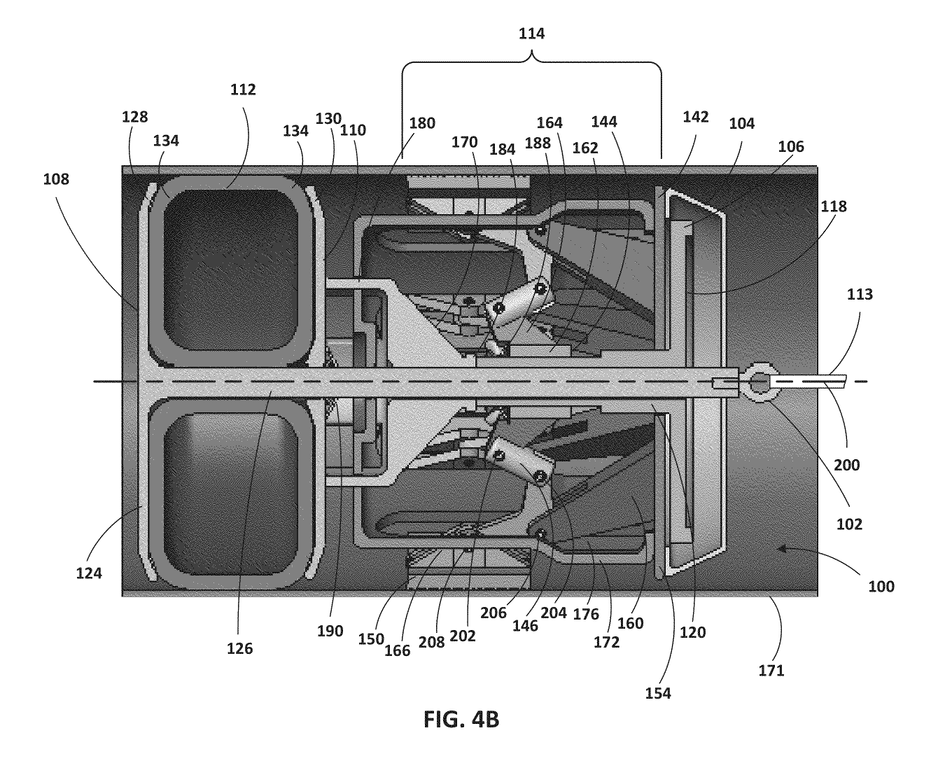

Packer 100 can be deployed at a number of locations within the submerged pipeline to arrest pipeline failures like wet buckles. For example, packer 100 can be deployed along a suspended pipe span of the pipeline or further downpipe where the pipeline meets the sea floor. Wet buckle packer 100 is configured to automatically respond to water invasion into the inner diameter of the pipeline and rapidly deploy a sealing system that will prevent the laid pipeline from being flooded with sea water, which is described in more detail with reference to FIGS. 4A and 4B.

Hoist line 113 extends from hoist ring 102 up to, for example, a hoist machine on a pipelay vessel. In some examples, packer 100 can include hoist rings on both ends of the device to deploy multiple packers within a pipeline in space, series relation within the pipeline. Packer 100 is configured to be arranged within the pipeline such that the end including cap 104 faces the region of the pipeline that is at risk of a wet buckle (or other failure). Thus, in the example of FIG. 1, one packer could be deployed within suspended pipe span 28 closer to the surface than the likely location of the wet buckle in the sagbend of the “S” curve and another packer could be deployed within pipeline 14 on the other side of the possible wet buckle location, e.g., somewhere along sea floor 26.

In this example, the packer deployed closer to the surface would be arranged within suspended pipe span 28 such that perforated cap 104 faces down toward the likely location of the wet buckle in the sagbend. This upper packer could include a hoist line running from the end of the device including second spindle 108 and another line running from perforated cap 104 to the lower packer. The lower packer closer to sea floor 26 would be arranged within the pipeline such that cap 104 faces up toward the likely location of the wet buckle in the sagbend and the lower packer would be connected to the upper packer by the line coupled to the perforated caps of each device.

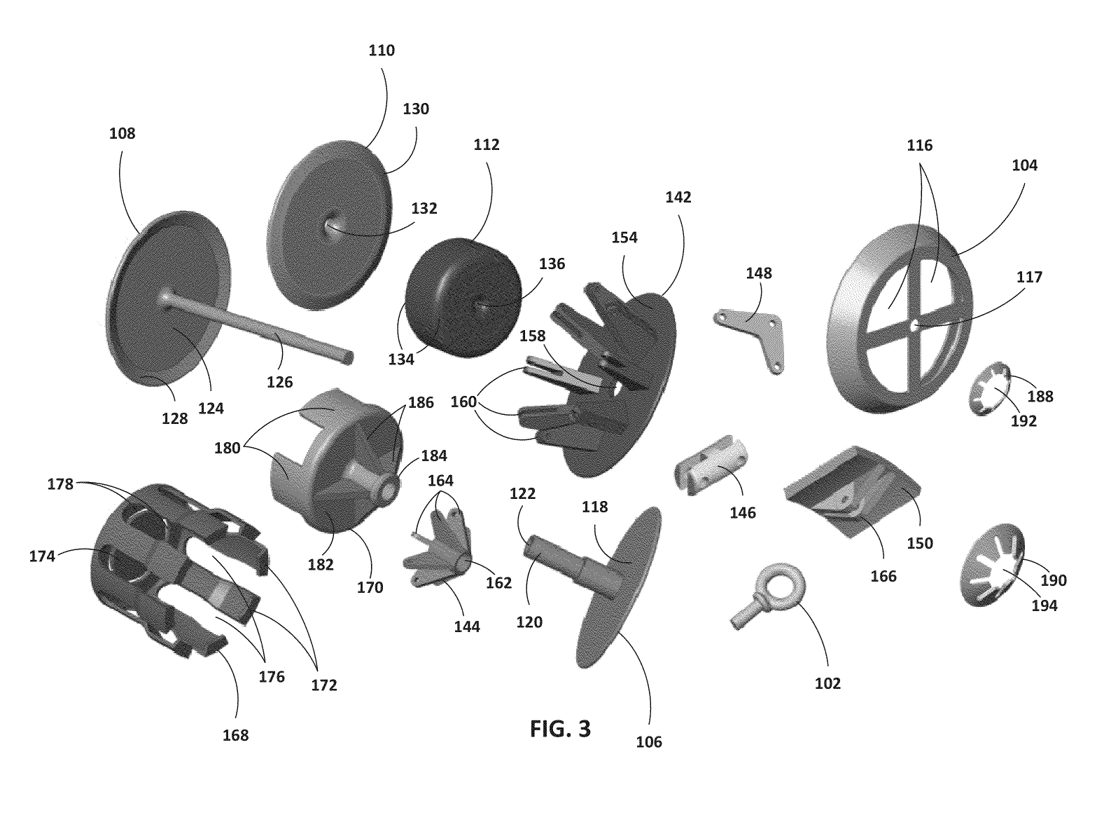

FIG. 3 depicts the components of packer 100 in an exploded view to illustrate the components in greater detail. Perforated cap 104 includes pie-piece shaped perforations 116. Cap 104 includes a frustoconical shape including two generally flat ends and a conical side extending between the ends. The interior of perforated cap 104 is hollow and sized to receive a portion of first spindle 106. Perforated end cap 104 also includes central thru hole 117.

First spindle 106 is configured to cause seal plate 110 to axially compress and radially expand expansion boot 112 and to actuate brake assembly 114. First spindle 106 includes end plate 118, central shaft 120, and bore 132. Central shaft 120 protrudes from end plate 118.

Second spindle 108 includes end plate 124 and central shaft 126, which protrudes from end plate 124. End plate 124 includes a tapered outer rim 128. End plate 124 of second spindle 108 generally defines one end of packer apparatus 100, while perforated cap 104 defines the opposite end of the device.

Seal plate 110 includes angled rim 130 and central thru hole 132. Expansion boot 112 includes rounded edges 134 and central thru hole 136.

Brake assembly 114 includes brake mandrel 142, expansion wing 144, a plurality of brake clevises 146, levers 148, and brake pads 150 (only one of each is illustrated in FIG. 3). Brake mandrel 142 includes end plate 154 with central thru hole 158. Central thru hole 158 is configured to receive central shaft 120 of first spindle 106. Brake mandrel 142 also includes a plurality of clevises 160 disposed at different angularly disposed, circumferential positions about a longitudinal axis of packer 100. Expansion wing 144 of brake 122 includes central shaft 162 and wings 164 protruding radially outward from shaft 162. Wings 164 are disposed at different angular positions about the circumference of central shaft 162. Shaft 162 is configured to receive central shaft 120 of first spindle 106. Brake pad 150 has an arcuate shape and includes clevis 166 extending radially inward from the inner surface of pad 150. Lever 148 includes a “V,” generally boomerang shape.

Packer 100 also includes packer mandrel 168 and seal actuator 170, which is configured to be axially aligned with and at least partially arranged within packer mandrel 168. Packer mandrel 168 includes a plurality of fingers 172, which are circumferentially disposed about a longitudinal axis of packer 100 and extend axially from end plate 174. Fingers 172 are offset from one another defining a plurality of axially extending slots 176. End plate 174 includes a number of arcuate slots 178.

Seal actuator 170 includes a plurality of arcuate flanges 180, which are circumferentially disposed about a longitudinal axis of packer 100 and extend axially from plate 182. Seal actuator 170 also includes central shaft 184 extending axially from plate 182 in the opposite direction from arcuate flanges 180. Central shaft 184 is supported and strengthened by buttresses 186, which are circumferentially disposed about shaft 184. Arcuate slots 178 of packer mandrel 168 are configured to receive arcuate flanges 180 of seal actuator 170.

Packer 100 also includes two lock washers 188 and 190, which are configured to lock packer in an engaged state with expansion boot 112 and brake assembly 114 engaging the inner surface of pipeline 171. Lock washers 188 and 190 include respective central apertures 192 and 194. Central aperture 192 of lock washer 188 is configured to receive central shaft 120 of first spindle 106. Central aperture 194 of lock washer 190 is configured to receive central shaft 126 of second spindle 108.

FIGS. 4A and 4B depict section views of wet buckle packer 100 within pipeline 171. In FIG. 4A, packer 100 is unengaged with pipeline 171. In FIG. 4B, packer 100 is engaged with pipeline 171 to substantially seal the inner diameter of pipeline 171 from water invasion. As illustrated in the section views of FIGS. 4A and 4B, the components of packer 100 are axially aligned along longitudinal axis 200 of packer 100. The components of packer 100 are generally axially aligned by central shaft 126 of second spindle 108 and central shaft 120 of first spindle 106. Central shaft 126 of second spindle 108 is received in each of central hole 136 of expansion boot 112, central hole 132 of seal plate 110, central aperture 194 of lock washer 190, shaft 184 of seal actuator 184, bore 122 of first spindle 106, and central hole 117 of perforated cap 104. Central shaft 120 of first spindle 106, which receives central shaft 126, is received in central hole 158 of brake mandrel 142, shaft 162 of expansion wing 144, and central aperture 192 of lock washer 188.

Perforated cap 104 is connected to brake mandrel 142, which is connected to fingers 172 of packer mandrel 168. Perforated cap 104, brake mandrel 142, and fingers 172 of packer mandrel 168 can be connected by a variety of mechanisms including, e.g., fasteners or welds. Cap 104, brake mandrel 142, and packer mandrel 168 can be connected to one another by a variety of mechanisms, including, e.g., using fasteners or welding the components to one another. End plate 118 of first spindle 106 is received within cap 104. Central shaft 120 extends through central hole 158 of brake mandrel 142 and shaft 162 of expansion wing 144 to abut shaft 184 of seal actuator 170. Seal actuator 170 is partially received within packer mandrel 168. Arcuate flanges 180 of seal actuator 170 pass through arcuate slots 178 of packer mandrel 168.

Expansion boot 112 is a hollow elastomeric boot including central hole 136 that receives central shaft 126 of second spindle 108. In another example, expansion boot 112 is not hollow. Expansion boot 112 is arranged between end plate 124 of second spindle 108 and seal plate 110. As end plate 118 of first spindle 106 moves axially toward end plate 124 of second spindle 108, expansion boot 112 is compressed axially. As expansion boot 112 is compressed axially, boot 112 also radially expands into engagement with an inner surface of pipeline 171. Rounded edges 134 of expansion boot 112 and angled rims 128 and 130 of end plate 124 and seal plate 110, respectively, may be configured to bias expansion boot 112 to move radially outward, instead of inward, when boot 112 is compressed axially between seal plate 110 and end plate 124.

As noted above, brake assembly 114 includes brake mandrel 142, expansion wing 144, brake clevises 146, levers 148, and brake pads 150. Central shaft 120 of first spindle 106 is received in central shaft 162 of expansion wing 144. Expansion wing 144 is configured to move axially with first spindle 106. Brake clevises 146 and levers 148 are pivotally connected between wings 164 of expansion wing 144 and clevises 160 of brake mandrel 142. In particular, brake clevises 146 are pivotally connected to wings 164 at pivot 202 and to levers 148 at pivot 204. Levers 148 are pivotally connected to clevises 160 of brake mandrel 142 at pivot 206 and to clevises 166 of brake pads 150 at pivot 208. As expansion wing 144 is moved axially by first spindle 106, brake clevises 146 and levers 148 pivot and levers 148 push brake pads 150 radially outward to engage the inner surface of pipeline 171, and to set brake assembly 114.

Packer 100 is configured to be automatically actuated in the event of a wet buckle of pipeline 171. In such an event, water invades pipeline 171 and flows through the inner diameter of the pipe toward cap 104. End plate 118 of first spindle 106 is configured to move axially within cap 104. Without the application of an external force like the pressure produced by water in pipeline 171, end plate 118 is positioned toward the end of perforated cap 104 to which hoist ring 102 is connected, as illustrated in FIG. 4A. When the wet buckle occurs, water invading pipeline 171 passes through perforations 116 in cap 104 and strikes end plate 118 of first spindle 106, which moves end plate 118 axially toward end plate 124 of second spindle 108, i.e. toward the opposite end of packer 100. The surface of end plate 118 presents a large surface area against which the water invading pipeline 171 can strike.

As the pressure of the water pushes end plate 118 of first spindle 106 axially toward end plate 124 of second spindle 108, central shaft 120 of first spindle 106 moves axially through hole 158 of brake mandrel 142 and strikes shaft 184 of seal actuator 170. Central shaft 120 pushes seal actuator 170 against seal plate 110. In particular, central shaft 120 pushes arcuate flanges 180 of seal actuator 170 through arcuate slots 178 of packer mandrel 168. Arcuate flanges 180 push seal plate 110 toward end plate 124 of second spindle 108. As seal plate 110 moves axially toward end plate 124 of second spindle 108, expansion boot 112 is compressed axially between disk 110 and plate 124. As expansion boot 112 is compressed axially, boot 112 also radially expands into engagement with an inner surface of pipeline 171. In the radially expanded state illustrated in FIG. 4B, expansion boot 112 are configured to substantially seal pipeline 171 and thereby arrest or mitigate the wet buckle in the pipeline.

In some examples, packer 100 can include an actuator that either augments the effect of the water pressure on end plate 118 of first spindle 106 or is employed in lieu of automatic actuation by the water pressure. For example, in the event the water pressure fails to actuate the device, packer 100 could include an actuator that drives first spindle 106 to seal pipeline 171 and set brake assembly 114. Example actuators that could be employed with packer 100 include a variety of mechanical and electromechanical devices that are configured to be actuated to drive first spindle 106. For example, the actuator can include a pneumatically or hydraulically actuated piston that drives actuator disk 106 with air or a hydraulic fluid supplied by a supply line connected to packer 100. In another example, the actuator includes an electrically activated solenoid that drives first spindle 106. In another example, the actuator includes an electromagnetic piston that drives actuator disk 106 based on controlled electricity transmitted to packer 100 via the supply line.

In some examples, packer 100 can include a sensor system that detects the invasion of water into the inner diameter of pipeline 171. In another example, the sensor system can be associated with a separate component and be communicatively coupled to packer 100. In one example, the sensor system includes a water sensor including two spaced electrodes arranged within pipeline 171 such that water invading the pipeline would complete an electrical circuit of the sensor. In another example, a pressure sensor could be used to detect the invasion of water into the inner diameter of pipeline 118. The sensor system communicatively coupled to packer 100 can provide a signal directly to control electronics included in an actuator of packer 100 or can transmit signals to a surface system, which, in turn, transmits control signals to an actuator via a supply line. Wet buckle detection via such a sensor system could be employed to test or verify whether packer 100 is actuated and, in some examples, could be used as a trigger to activate an actuator included in packer 100.

In conjunction with axial movement of first spindle 106 to cause expansion boot 112 to engage pipeline 171, brake assembly 114 is also deployed to prevent or substantially inhibit movement of packer 100 within pipeline 171. For example, as the pressure of the water strikes end plate of first spindle 106, central shaft 120 moves axially through central hole 158 of brake mandrel 142. Central shaft 120 of first spindle 106 moves expansion wing 144 axially away from cap 104. Axial movement of expansion wing 144 causes wings 164 to move brake clevises 146. Brake clevises 146 rotate about pivot 202 and pivot 204 and cause levers 148 to rotate about pivot 206. Levers 148 rotating about pivot 206 causes levers 148 to push brake pads 150 radially outward into engagement with the inner surface of pipeline 171. The outer surfaces of brake pads 150 include a saw-tooth profile defined by a series of circumferentially extending ridges (see FIG. 2), which are configured to engage the inner surface of pipeline 171 without slipping. In many examples, the ridges will not be symmetrical, but will be configured particularly to prevent movement in the direction toward the end of packer 100 including second spindle 108 (i.e., away from the likely location of water influx due to a wet buckle). In one example, pads 150 are manufactured from steel and, in some cases, can include carbide buttons that form the saw-tooth profile of pads 150.

Packer 100 is configured such that in the unengaged state illustrated in FIG. 4A at least some portions of the outer boundaries of packer 100 are offset from the inner surface of pipeline 171. The offset distance between packer 100 and the inner surface of pipeline 171 may differ at different points along the axial length of packer 100. For example, offset 210 between expansion boot 112 and the inner surface of the pipeline 171 is different than offset 212 between brake pads 150 and the inner surface of pipeline 171. The outer periphery of end plate 124 of second spindle 108, expansion boot 112, and seal plate 110 may be configured to fit closely with the inner surface of pipeline 171 even when packer 100 is in an unengaged state. In one example, packer 100 is designed such that offset 210 is less than or equal to ⅛ inch, while offset 212 is greater than ⅛ inch. However, in other examples, offset 210 and offset 212 can be larger or smaller depending on the clearance between packer 100 and pipeline 171 necessary to allow packer 100 to be deployed through pipeline 171 and the amount of radial expansion of seal plate 110 and brake pads 150 that is provided when first spindle 106 moves axially toward second spindle 108.

Although particular offset distances are described with reference to example packer 100, a packer in accordance with this disclosure will be constructed with a desired dimensional relationship with the dimensions of the pipeline in which the device is to be used. In one example configuration, a radial clearance of approximately ⅛ inch will separate the sealing element of the packer and the pipeline inner surface and a radial clearance of approximately ¼ inch will separate the braking element of the packer and the pipeline inner surface. However, as will be apparent to persons skilled in the art, difference radial dimensions may be used for any size pipe, and in some cases such dimensions may be determined by other factors, such as the designed radius of bends the pipeline will experience while being installed on the sea floor, and/or the intended characteristic of the internal welds used to join the pipeline sections.

In some cases, it may be desirable to configured packer 100 such that offset 210 between expansion boot 112 and the inner surface of the pipeline 171 is as small as possible while still allowing packer 100 to be deployed downpipe within pipeline 171. In one example, the outer periphery of expansion boot 112 is configured to abut or nearly abut the inner surface of pipeline 171 even in the unengaged state of packer 100, as illustrated in FIG. 4A. In practice, there may be a delay between the occurrence of a wet buckle to pipeline 171 and water striking end plate 118 of first spindle 106 to cause packer 100 to become engaged with the inner surface of pipeline 171. During the delay in actuation of packer 100 some water may pass through packer 100. Reducing offset 210 between expansion boot 112 and the inner surface of the pipeline 171 will reduce the amount of water that floods pipeline 171 before packer 100 is engaged and expansion boot 112 substantially seals the inner diameter of the pipeline.

As is illustrated in FIG. 4A, cap 104 and expansion boot 112 are hollow and brake mandrel 142, packer mandrel 168, and seal actuator 170 are relatively thin-walled components. It may be desirable to design the components of packer 100 and other wet buckle packers in accordance with this disclosure in order to reduce the weight of the device. Packer 100 may be employed in relatively large pipelines. In one example, pipeline 171 has an inner diameter that is approximately equal to 40 inches. The large size of pipeline 171 necessitates a relatively large packer to seal the inner diameter of the pipeline. As such, in one example, packer 100 may weigh on the order of thousands of pounds. In such situations, removing as much material from cap 104, expansion boot 112, brake mandrel 142, packer mandrel 168, seal actuator 170, and other components of packer 100 can have a significant impact on the weight of the device.

The overall weight of packer 100 also affects the amount of load on hoist line 113 and, as a result, the amount of work required by the hoist machine operating hoist line 113. As such, reducing the weight of packer 100 can also reduce the cost and complexity of deploying packer 100 via hoist line 113.

The forces encountered by packer 100 in the event of a wet buckle of pipeline 171 may be significant. For example, at a relatively shallow depth of approximately 1500 feet below sea level, the pressures generated by a wet buckle can reach approximately 660 pounds per square inch (psi). At a depth of approximately 12,000 feet, the pressures generated by a wet buckle can reach approximately 5280 psi. In view of the range of forces potentially encountered by wet buckle packer 100, the wall thicknesses of the components of packer 100 may need to be adjusted to withstand large forces/pressures.

Forces encountered by different portions of packer 100 may differ significantly. For example, portions of packer 100 may be partially or substantially pressure balanced because water introduced into pipeline 171 is allowed to enter parts of packer 100. In such situations, the pressure of the water is balanced on particular portions of packer 100. For example, water may be allowed to enter portions of packer 100 such that the water pressure is balanced on either side of a wall of one or more of cap 104, seal plate 110, brake mandrel 142, packer mandrel 168, and seal actuator 170. In one example, a seal is provided between the outer diameter on first spindle 106 and the inner diameter of cap 104. In such a case, the only components of packer 100 substantially affected by pressure differentials will be cap 104, first spindle 106 and expansion boot 112. In some examples, therefore, packer 100 may be designed to allow pressure balancing of some portions of the device such that the wall thicknesses of different portions of cap 104, seal plate 110, brake mandrel 142, packer mandrel 168, seal actuator 170, and other components of packer 100 may differ significantly depending on the amount of pressure/force encountered in the event of a wet buckle.

A variety of materials can be used to fabricate the components of packer 100 including, e.g., metals, plastics, elastomers, and composites. For example, cap 104, first spindle 106, second spindle 108, seal plate 110, brake mandrel 142, expansion wing 144, brake clevises 146, levers 148, packer mandrel 168, brake pads 150, and seal actuator 170 can be fabricated from a variety of different types of steel or aluminum. Expansion boot 112 can be fabricated from a variety of elastomeric materials including rubber. In one example, expansion boot 112 is fabricated from a nitrile rubber. At the sea floor, packer 100 may encounter temperatures as low as 32 degrees Fahrenheit (0 degrees Celsius). As such, expansion boot 112 may need to be fabricated from elastomers that can withstand relatively low temperatures without significantly affecting the material properties of disk 108. For example, expansion boot 112 may need to be fabricated from elastomers that can withstand relatively low temperatures without causing boot 112 to become too hard, stiff and/or brittle such that the disks are incapable of sufficiently sealing the inner diameter of pipeline 171. The components of packer 100 can be fabricated using a variety of techniques including, e.g., machining, injection molding, casting, and other appropriate techniques for manufacturing such parts.

Packer 100 also includes a locking mechanism including lock washer 188 surrounding central shaft 120 of first spindle 106 and lock washer 190 surrounding central shaft 126 of second spindle 108. Both lock washers 188 and 190 allow movement in one direction, while preventing movement in the opposite direction. For example, lock washer 188 is disposed such that first spindle 106 including central shaft 120 can move axially toward second spindle 108, but prevents first spindle 106 from moving away from second spindle 108. Lock washer 190 is coupled to seal plate 110. Lock washer 190 is disposed such that washer 190 can be pushed toward second spindle 108 along with seal plate 110, but prevents seal plate 110 from moving away from second spindle 108 after packer 100 has been engaged. A rack and pawl ratchet system may also be employed. An example ratchet mechanism that could be configured for use with packer 100 is disclosed and described in described in U.S. application Ser. No. ______ (Atty. Docket No. 1880.517US1), filed July ______, 2013 and entitled “METHODS AND APPARATUS FOR ARRESTING FAILURES IN SUBMERGED PIPELINES,” the entire contents of which are incorporated herein by reference.

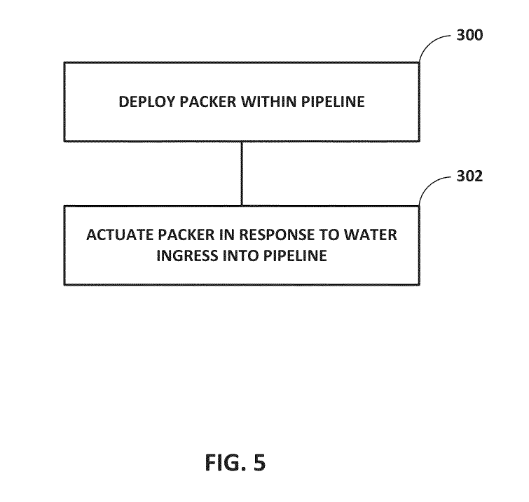

FIG. 5 is a flowchart depicting an example method of arresting a failure of a submerged pipeline. The method includes deploying a packer apparatus within the pipeline (300) and actuating the packer apparatus in response to water ingress into the pipeline (302). The packer apparatus can be deployed into the pipeline via a hoist line connected to a hoist machine on a pipelay vessel. In one example, the packer apparatus that is employed in conjunction with the example method of FIG. 5 is similar to packer 100 described above. As such, in one example, packer 100 employed to carry out the method of FIG. 5 includes first spindle 106 in axial moveable relation with second spindle 108. First spindle 106 includes pressure plate 118 disposed adjacent a first end of the packer 100 including cap 104. Second spindle 108 includes shaft 126 and base plate 124 disposed adjacent a second end of packer 100 opposite the first end. Packer 100 also includes seal plate 110 disposed between pressure and base plates 118 and 124, respectively, brake assembly 114 disposed between pressure and seal plates 118 and 110, respectively, and elastomeric expansion boot 112 disposed between seal and base plates 110 and 124, respectively.

Packer 100 is actuated in response to and as a result of water ingress into the pipeline. For example, actuating packer 100 can include moving first spindle 106 axially toward second spindle 108 from a first position to a second position. First spindle 106 is moved from the first to the second position as a result of fluid pressure generated by the water in the pipeline. The fluid pressure of the water in the pipeline acts to push pressure plate 118 of first spindle 106, which drives spindle 106 including central shaft 120 axially toward base plate 124 of second spindle 108. In the second position, central shaft 120 of first spindle 106 drives seal actuator 170 against seal plate 110. Seal plate 110 is moved axially toward base plate 124 to axially compress and radially expand expansion boot 112 into engagement with the inner surface of the pipeline. Additionally, in the second position, brake assembly 114 pivots relative to brake mandrel 142, which causes brake assembly 114 to move radially outward into engagement with the inner surface of the pipeline.

As described above, methods of arresting failures of a submerged pipeline can include deploying multiple packers within the submerged pipeline. In one example, the packers are deployed on either side (e.g. one closer to the surface and one farther from the surface and closer to the sea floor) of the likely location of the wet buckle (or other failure). In such examples, both packers can be actuated to seal the region of the pipeline between the packers and including the location of the failure.

As described above, the method of FIG. 5 includes actuation of a packer apparatus in response to water ingress into a pipeline. As illustrated by the examples of packer 100, the packer can not only be actuated in response to but also as a result of the water the water in the pipeline. In other words, the packer actuation is automatically caused by fluid pressure generated by the water invading the pipeline. Thus, the example method of FIG. 5 can be carried out with any packer apparatus that is configured to be automatically actuated by fluid pressure within a pipeline. Additional examples of such apparatus are disclosed and described in U.S. application Ser. No. ______ (Atty. Docket No. 1880.517US1), filed on July ______, 2013, U.S. application Ser. No. ______ (Atty. Docket No. 1880.519US1), filed on July ______, 2013, and U.S. application Ser. No. ______ (Atty. Docket No. 1880.563US1), filed on July ______, 2013, all of which are entitled “METHODS AND APPARATUS FOR ARRESTING FAILURES IN SUBMERGED PIPELINES,” and the entire contents of all of which are incorporated herein by reference.

Various examples have been described. These and other examples are within the scope of the following claims.

I claim:

1. A packer apparatus configured to be arranged within and arrest a failure of a submerged pipeline, the packer apparatus comprising:
a first spindle in axial moveable relation with a second spindle, wherein the first spindle comprises a pressure plate disposed adjacent a first end of the packer apparatus, and wherein the second spindle comprises a base plate disposed adjacent a second end of the packer apparatus;
a seal plate disposed between the pressure and base plates;
a brake disposed between the pressure and seal plates;
an elastomeric expansion boot disposed between the seal and base plates, and
wherein the pressure plate is configured to be actuated by fluid pressure within the pipeline to move the first spindle axially toward the second spindle from a first position to a second position, and
wherein, in the second position, the first spindle causes:
the brake to move radially outward into engagement with an inner surface of the pipeline; and
the seal plate to move axially toward the base plate to axially compress and radially expand the expansion boot into engagement with the inner surface of the pipeline.

2. The apparatus of claim 1, further comprising an end cap within which the pressure plate of the first spindle is received, and wherein apertures in the end cap are configured to allow a pressurized fluid to pass through the end cap to apply pressure to the pressure plate to move the first spindle axially toward the second spindle from the first position to the second position.

3. The apparatus of claim 1, wherein, in the first position of the first spindle, the expansion boot is in a radially unexpanded state and the brake is unengaged with the inner surface of the pipeline.

4. The apparatus of claim 1, wherein the second spindle comprises a shaft extending from the base plate, and wherein the shaft is received in an aperture in each of the first spindle, the seal plate, the brake, and the expansion boot.

5. The apparatus of claim 2, wherein:
the brake comprises a mandrel;
the first spindle is in axial moveable relation with the mandrel;
the brake is pivotally connected to the first spindle and the mandrel; and
in the second position, the first spindle moves axially relative to the mandrel, which causes the brake to pivot relative to the first spindle and the mandrel and to move radially outward into engagement with the inner surface of the pipeline.

6. The apparatus of claim 5, wherein the brake comprises a plurality of brake mechanisms pivotally connected to the first spindle and the mandrel and disposed at different angularly disposed, circumferential positions about a longitudinal axis of the packer apparatus.

7. The apparatus of claim 6, wherein each brake mechanism comprises:
a linkage; and
a pad arranged adjacent a first end of the linkage,
wherein the linkage is pivotally connected to the first spindle at a second end of the linkage generally opposite the first end and pivotally connected to the mandrel between the first and second ends.

8. The apparatus of claim 7, wherein the first spindle comprises a shaft, and wherein the shaft of the first spindle is received in a central aperture of the mandrel.

9. The apparatus of claim 8, further comprising a plurality of clevises protruding radially outward from different angularly disposed, circumferential positions about the circumference of the shaft of the first spindle, and wherein:
the mandrel comprises a plurality of clevises disposed at different angularly disposed, circumferential positions about a longitudinal axis of the packer apparatus; and
for each brake mechanism, the linkage is pivotally connected to one of the clevises protruding from the shaft of the first spindle at the second end and pivotally connected to one of the clevises of the mandrel between the first and second ends.

10. The apparatus of claim 9, wherein, for each brake mechanism, the linkage is pivotally connected to the pad at the first end.

11. The apparatus of claim 8, further comprising a locking mechanism configured to lock the seal plate axially toward the base plate such that the expansion boot is axially compressed and radially expanded into engagement with the inner surface of the pipeline and to lock the brake in radially outward engagement with the inner surface of the pipeline.

12. The apparatus of claim 11, wherein the brake lock mechanism comprises:
a first lock washer comprising a first aperture that receives the shaft of the first spindle; and
a second lock washer comprising a second aperture that receives the shaft of the second spindle.

13. The apparatus of claim 7, wherein each linkage comprises a link comprising a generally boomerang shape.

14. The apparatus of claim 7, wherein the expansion boot comprises a nitrile rubber.

15. A system for arresting a failure of a submerged pipeline,
the system comprising:
a hoist machine;
a packer apparatus configured to be arranged within the submerged pipeline, wherein the packer apparatus comprises:
a first spindle in axial moveable relation with a second spindle, wherein the first spindle comprises a pressure plate disposed adjacent a first end of the packer apparatus, and wherein the second spindle comprises a base plate disposed adjacent a second end of the packer apparatus;
a seal plate disposed between the pressure and base plates;
a brake disposed between the pressure and seal plates;
an elastomeric expansion boot disposed between the seal and base plates, and
wherein the pressure plate is configured to be actuated by fluid pressure within the pipeline to move the first spindle axially toward the second spindle from a first position to a second position, and
wherein, in the second position, the first spindle causes:
the brake to move radially outward into engagement with an inner surface of the pipeline; and
the seal plate to move axially toward the base plate to axially compress and radially expand the expansion boot into engagement with the inner surface of the pipeline; and
a hoist line comprising a first end operatively connected to the hoist machine and a second end connected to the packer apparatus.

16. The system of claim 15, further comprising an end cap within which the pressure plate of the first spindle is received, and wherein apertures in the end cap are configured to allow a pressurized fluid to pass through the end cap to apply pressure to the pressure plate to move the first spindle axially toward the second spindle from the first position to the second position.

17. The system of claim 15, wherein the second spindle comprises a shaft extending from the base plate, and wherein the shaft is received in an aperture in each of the first spindle, the seal plate, the brake, and the expansion boot.

18. The system of claim 17, wherein:
the brake comprises a mandrel;
the first spindle is in axial moveable relation with the mandrel;
the brake is pivotally connected to the first spindle and the mandrel; and
in the second position, the first spindle moves axially relative to the mandrel, which causes the brake to pivot relative to the first spindle and the mandrel and to move radially outward into engagement with the inner surface of the pipeline.

19. The system of claim 18, wherein the brake comprises a plurality of brake mechanisms pivotally connected to the first spindle and the mandrel and disposed at different angularly disposed, circumferential positions about a longitudinal axis of the packer apparatus, and wherein each brake mechanism comprises:
a linkage; and
a pad arranged adjacent a first end of the linkage,
wherein the linkage is pivotally connected to the first spindle at a second end of the linkage generally opposite the first end and pivotally connected to the mandrel between the first and second ends.

20. The system of claim 19, wherein the first spindle comprises a shaft, and wherein the shaft of the first spindle is received in a central aperture of the mandrel.

21. The system of claim 20, further comprising a plurality of clevises protruding radially outward from different angularly disposed, circumferential positions about the circumference of the shaft of the first spindle, and wherein:
the mandrel comprises a plurality of clevises disposed at different angularly disposed, circumferential positions about a longitudinal axis of the packer apparatus; and
for each brake mechanism, the linkage is pivotally connected to one of the clevises protruding from the shaft of the first spindle at the second end and pivotally connected to one of the clevises of the mandrel between the first and second ends.

22. The system of claim 20, further comprising a locking mechanism configured to lock the seal plate axially toward the base plate such that the expansion boot is axially compressed and radially expanded into engagement with the inner surface of the pipeline and to lock the brake in radially outward engagement with the inner surface of the pipeline.

23. The system of claim 22, wherein the brake lock mechanism comprises:
a first lock washer comprising a first aperture that receives the shaft of the first spindle; and
a second lock washer comprising a second aperture that receives the shaft of the second spindle.

24. The system of claim 19, wherein the expansion boot comprises a nitrile rubber.

25. A system for arresting a failure of a submerged pipeline, the system comprising:
a first packer apparatus configured to be disposed at a first position within the pipeline; and
a second packer apparatus configured to be disposed at a second position within the pipeline,
wherein at least one of the first and the second packer apparatus comprises:
a first spindle in axial moveable relation with a second spindle, wherein the first spindle comprises a pressure plate disposed adjacent a first end of the packer apparatus, and wherein the second spindle comprises a base plate disposed adjacent a second end of the packer apparatus;
a seal plate disposed between the pressure and base plates;
a brake disposed between the pressure and seal plates;
an elastomeric expansion boot disposed between the seal and base plates, and
wherein the pressure plate is configured to be actuated by fluid pressure within the pipeline to move the first spindle axially toward the second spindle from a first position to a second position, and
wherein, in the second position, the first spindle causes:
the brake to move radially outward into engagement with an inner surface of the pipeline; and
the seal plate to move axially toward the base plate to axially compress and radially expand the expansion boot into engagement with the inner surface of the pipeline.

26. A method of arresting a failure of a submerged pipeline, the method comprising:
deploying a packer apparatus within the pipeline, wherein the packer apparatus comprises:
a first spindle in axial moveable relation with a second spindle, wherein the first spindle comprises a pressure plate disposed adjacent a first end of the packer apparatus, and wherein the second spindle comprises a base plate disposed adjacent a second end of the packer apparatus;
a seal plate disposed between the pressure and base plates;
a brake disposed between the pressure and seal plates;
an elastomeric expansion boot disposed between the seal and base plates, and actuating the packer apparatus in response to water ingress into the pipeline,
wherein actuating the packer apparatus comprises moving the pressure plate of the first spindle axially toward the second spindle from a first position to a second position, and
wherein, in the second position, the first spindle causes:
the brake to move radially outward into engagement with an inner surface of the pipeline; and
the seal plate to move axially toward the base plate to axially compress and radially expand the expansion boot into engagement with the inner surface of the pipeline.
